(19) United States
(12) Patent Application Publication
(10) Pub. No.: US 2004/0130218 A1
(43) Pub. Date: Jul. 8, 2004

(54) Modular power distribution system and method

(75) Inventor: Gary J. Locke, Endicott, NY (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: Lockheed Martin Corporation

(21) Appl. No.: 10/338,357

(22) Filed: Jan. 8, 2003

(51) Int. Cl. H02G 1/00

(52) U.S. Cl. 307/147

(57) ABSTRACT

A system distributes power. The system includes a hub for providing a specific power criteria and a trunk for transferring power from the hub a power consuming device. A first branch, a second branch, and a third branch transfer power from the trunk. The system has a first condition wherein the first branch transfers power to a first pass-thru receptacle, a second pass thru receptacle, and a first sub-branch. The first sub-branch includes a first twig and a second twig. The second twig powers the power consuming device. The second branch, in the first condition, transfers power to a third pass-thru receptacle and a fourth non-pass-thru receptacle. The third branch, in the first condition, transfers power to a first switch and a fifth pass-thru receptacle. The first switch controls power to a second sub-branch. The system further has a second condition for modularly augmenting the first condition by adding a fourth branch, a fifth branch, and a sixth branch. The system is converted from the first condition to the second condition by a common source of components.

### TECHNICAL FIELD

The present invention relates to a power distribution system and, more particularly, to a modular power distribution system, apparatus, and method.

### BACKGROUND OF THE INVENTION

A complete power distribution system cannot typically be factory assembled prior to field deployment, nor can repetitive system configurations be implemented effectively. Complete modularity of system design, and flexibility of format, are desired to satisfy unique system configurations at a final assembly site.

One approach may be to maintain a repository of power distribution hardware designs that are ready for use by virtually any application.

### SUMMARY OF THE INVENTION

In a dynamic manufacturing, processing, construction, or information system environments, modularity of system design, and flexibility of format, are required to satisfy unique system configurations that are subject to repeated change. A power distribution system in accordance with the present invention satisfies design modularity and flexibility requirements relative to final assembly, re-configuration, and reuse of power distribution systems for 120 VAC utilization equipment configured with National Electrical Manufacturers Association (NEMA) 5-15 and 5-20 plugs.

A pre-manufactured Power Distribution System (PDS) is a solution for 120 volt AC power distribution that is modular in nature with the elements mapping directly to the intended application. The installation of PDS elements requires nothing more than hand tools to install, and can be characterized as completely “plug and play”. The “plug and play” nature of PDS serves to facilitate a zero defect 120 volt AC power distribution solution in the shortest possible time.

In accordance with the present invention, a system, apparatus, or method are intended for use during all program or project phases including proposal, prototype, pre-production, first article, and production. The Pre-Manufactured Power Distribution System (PDS) positively impacts the competitive position of the solution user with long term cost reductions and improved efficiency. Those areas of cost reduction and improved efficiency include engineering and design nonrecurring expenses, engineering support activities, technical data package maintenance, prototyping, piece part costs, manufacturing setup and labor, logistical support activities, installation and field service activities, system re-configuration, system maintenance and repair operations, extended design life cycle, and system element re-use.

The PDS architecture allows a program or project office to enhance its overall competitive performance positions by providing a superior cost benefit solution in the area of 120 VAC power distribution. With a PDS solution, power distribution costs are stabilized and significantly reduced. When in a proposal phase, a PO can use actual PDS costs with high degrees of confidence relative to design, procurement, manufacturing, installation, and integrated logistical support. PDS designs are intended for 120 VAC power distribution applications from a number of separately derived sources of supply (i.e., 208/120 VAC 3 phase 4 wire wye connection with ground, 240/120 VAC 3 phase 4 wire delta connection with ground, 240/120 VAC 1 phase 3 wire with ground, 120 VAC 1 phase 2 wire with ground).

### BRIEF DESCRIPTION OF THE DRAWINGS

The foregoing and other advantages of the invention will become more readily apparent from the following description of a preferred embodiment of the invention as taken in conjunction with the accompanying drawings, which are a part hereof, and wherein:

FIGS. 1 and 2 are a schematic representation of a power distribution system in accordance with the present invention; and

FIG. 3 is a schematic representation of a power distribution system in accordance with the present invention.

### DESCRIPTION OF AN EXAMPLE EMBODIMENT

A pre-manufactured power distribution system (PDS) in accordance with the present invention may be applied to any process, system, or application that has National Electrical Manufacturers Association (NEMA) 5-15 and 5-20 plug connected equipment. Such applications include, but are not limited to, industrial manufacturing and processing system (automated, manual, or hybrid), process power, tool power, convenience power, illumination, construction, site power, computer room, information systems power, airports, marinas, trailer parks, RV parks, amusement park systems, architectural lighting systems, entertainment lighting systems, stage lighting, and/or airport runway lighting.

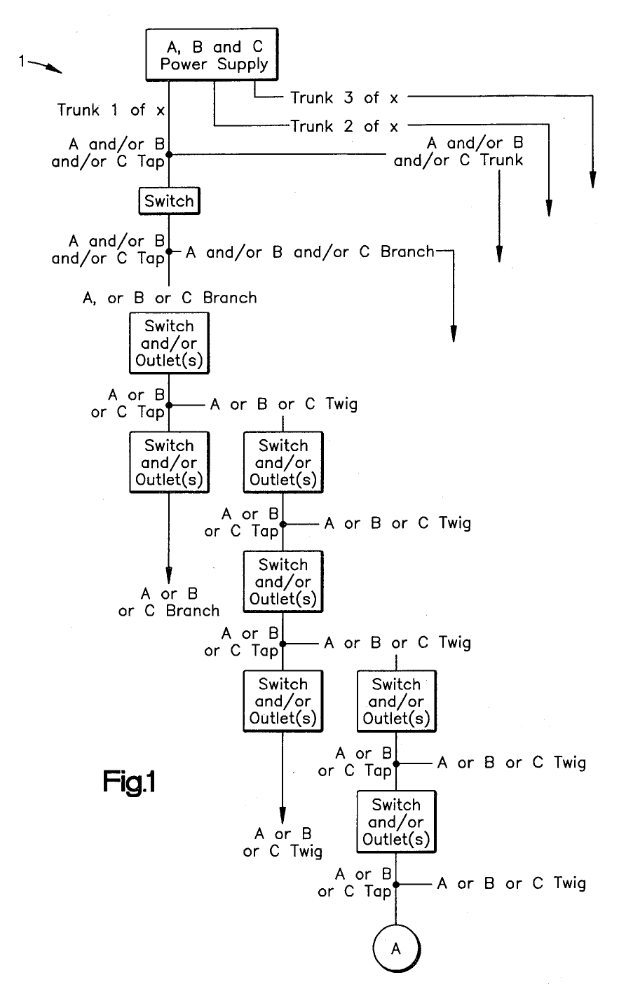

Each general application category requires specific feature attributes that are accommodated by the PDS. Modular PDS components are used in combination to tier up into a complete power distribution system architecture. The PDS includes three basic types of modular components that constitute the “three legs of a system”. As viewed in FIG. 1, those components include pre-manufactured power conversion units, or power assemblies (PPAs); pre-manufactured distribution assemblies (PDAs), and module inter-connectivity components (MICs).

To satisfy specific needs and requirements, a systems or facilities engineer typically combines PDAs, and MICs into kits. These two kits are then combined with a PPA to form a complete PDS bill of materials.

A PPA assembly constitutes a complete separately derived source of power as defined in NFPA 70—National Electrical Code with all associated equipment and devices. PPAs are grouped into families based on the output voltage, or specific power criteria, of the integrally derived source of power. The various PPA voltage assemblies may include 208/120 VAC 3 phase 4 wire wye connection with ground, 240/120 VAC 3 phase 4 wire delta connection with ground, 240/120 VAC 1 phase 3 wire with ground, and 120 VAC 1 phase 2 wire with ground.

Each family of PPAs may further be broken down to individual assemblies by the power rating in kilo-volt amperes (KVA), as follows: 3 phase assemblies—3, 4.5, 6, 9, 15, 30, and 45 KVA; and 1 phase assemblies—1, 1.5, 2, 3, and 5 KVA. Each base PPA design may have a number of variations for various mounting or installation styles including, but not limited to: enclosed 19″ rack mount enclosure, floor mountable; insertable, 19″ rack mount enclosure compatible; open, panel or sub-plate mountable in any enclosure suitable for the environment; and enclosed NEMA 12, wall mountable.

Each PPA design includes: assembly packaging, transformer primary disconnect, transformer primary protection, transformer with options that include super neutral, shielding, bonding, grounding electrode conductor provisions, transformer secondary protection, feeder circuit protection, and feeder MIC connections.

PDAs constitute the system control elements, utilization equipment, and the interface from the PDS to the NEMA 5-15 and 5-20 configured power consuming devices, or utilization equipment. The PDAs are configured to provide maximum application flexibility and are constructed in multiple configurations that are inclusive of a series of devices and utilization equipment. The basic PDA configurations include receptacle assemblies with or without power pass-through feature, one to five duplex receptacles, receptacle and switch combination assemblies with or without a power pass-through feature, one to five duplex receptacles with integral local, isolation switch, one to five duplex receptacles with integral local and remote isolation switch, isolation switch assemblies with power pass-through, single pole, double pole, triple pole, control switch assemblies, two way, three way, four way, luminaries with or without a power pass-through feature, high intensity discharge, fluorescent, and incandescent.

The NEMA 5-15 and 5-20 receptacle configuration options include specification grade, hospital grade, isolated ground, and surge suppression. General PDA construction features include NEMA rated enclosures, powder coating, device identification marking, environmental receptacle covers, switch lock-out feature, versatile mounting provisions, and MIC interface.

MICs are the connectorized cables used to interconnect the PDAs with other PDAs and associated PPA. The MIC solution allows for a complete “plug and play” system and unique configurations. The MIC solution is well defined, and provides a mature inter-connectivity interface proven in demanding, aggressive, industrial environments. The MICs are installed in accordance with the applicable provisions of NFPA 70 National Electrical Code, NFPA 79 Electrical Standard for Industrial Machinery, and Lockheed Martin PROJ-2002-LINKOSITY-0014 Rev. 1 Linkosity Connectivity System Configuration.

The PDA and MIC legs of a PDS solution are “kitted” separately based on the requirements of the application. The PDA and MIC kits are used together with a PPA to form a system kit.

Preferably, the PDAs are the first of the three legs of the PDS architecture to be defined. Based on the application power requirements, the appropriate PDAs are called out in a PDA kit bill of materials. The PPA is the second of the three legs of the PDS architecture to be defined. Based on the application equipment load and application power requirements, the appropriate PPA is identified. The MICs are the last of the three legs of the PDS architecture to be defined. Based on the application's logistical requirements, the appropriate MICs needed to interconnect the PPAs to the PDAs, and the PDAs to other PDAs are called out in a MIC kit bill of materials. The MIC kit will typically include a slight excess quantity of components relative to anticipated need so as to ensure the viability of the solution when exposed to change or oversight. The MICs are applied as required, in real time, as dictated by the situational needs of the application.

All kits are typically installed in accordance with an associated reference drawing. The reference drawing specifies all of the pertinent locations and interconnections for the applied PDS. The reference drawing expedites an effective field implementation facilitating the solution's interconnection. The reference drawing allows concurrent engineering to move forward at an accelerated rate without all of the perpetual rework typically associated with the concurrent engineering approach. The reference drawing also serves to expedite maintenance and repair operations because all system component interdependencies are detailed in a single location for ease of reference.

The PDS solution is based on the premise that designs should, to the greatest possible extent, be as user friendly as possible to the greatest number of users. The PDS solution will affect multiple users at various stages of implementation and use, and strives to find those practices that will best empower all users to the greatest practicable extent.

Typical solution methodology generally is totally situational in nature, therefore offering absolute flexibility in the field. Absolute flexibility, however, comes at a price as high installation expenses, long installation times, zero quality control, limited repeatability, and high maintenance costs can be expected. The PDS solution maintains the desired flexibility while mitigating or eliminating the associated cost detriments.

The PDS solution accomplishes the aforementioned while complying with the provisions of the applicable consensus standards relative to the potential application. Those consensus standards include NFPA 70 National Electrical Code, NFPA 79 Electrical Standard for Industrial Machinery, SAE H-1738 Standard for Electrical Equipment for Automotive Machinery, and EN60204-1 Electrical Equipment of Industrial Machines.

The PDS solution serves to minimize installer and user issues relative to consensus standard and code compliances. Ease of use with the least possible entanglements relative to inspection and acceptance is intended. This ease of use is accomplished by replacing what would otherwise be single installations uniquely done for each application with an engineered solution constructed in a total quality environment that achieves safe, repeatable results.

The PDS solution will typically reduce the users total cost of ownership relative to current market place alternatives, while at the same time will improve system delivery, performance, reliability, and safety.

FIGS. 1 and 2 illustrate an example system 1 in accordance with the present invention. The system 1 may be expanded from Trunk 1 to Trunk 2 to Trunk 3 and so on, being limited only by the power supply. The example power supply of FIG. 1 may be a three-phase supply (i.e., phases A, B, and C). The example power supply may be a self-contained, separately derived-source inclusive of a transformer that may be K-factor rated and/or shielded, a primary disconnect, primary and secondary protection, a grounding electrode, and/or a system connector. The example power supply may also have a power conditioning indication as well as surge suppression and/or line filtration. The power supply may further have internal or external (i.e., a separate plug-in unit) load balancing indicators for the trunks.

The trunks may transfer the three-phase power to the branches and twigs. Each trunk may have a current protection. The branches may tap into one, two, or all three phases of power, as illustrated in FIGS. 1 and 2. Any number and configurations of receptacles, switches, and combination receptacle outlet/switches may be powered by this system 1. The MICs may feature a superneutral and/or an isolated ground for sensitive equipment.

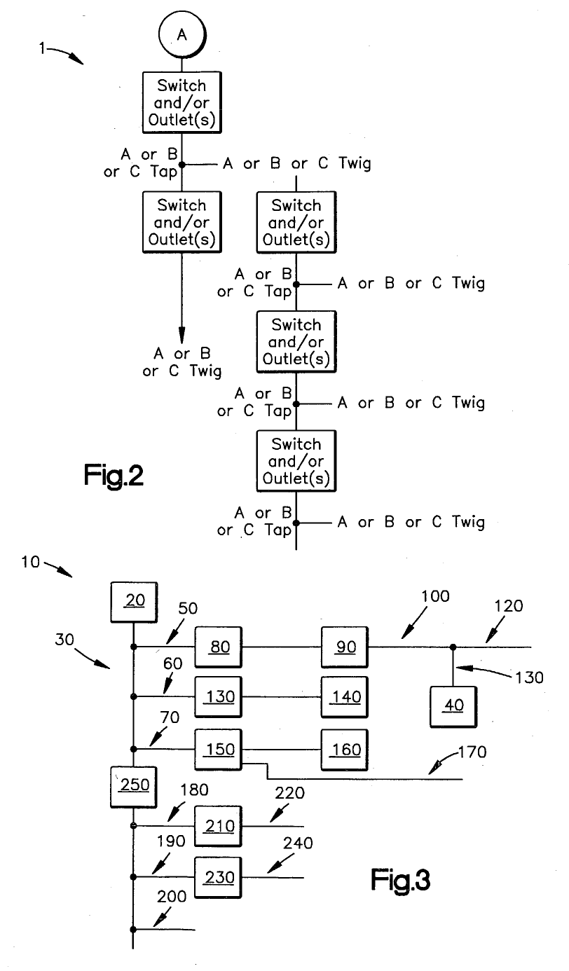

As illustrated in FIG. 3, a system 10 in accordance with the present invention distributes power. The system 10 includes a hub 20 for providing a specific power criteria and a trunk 30 for transferring power from the hub 20 a power consuming device 40. A first branch 50 transfers power from the trunk 30. A second branch 60 transfers power from the trunk 30. A third branch 70 transfers power from the trunk 30.

The system 10 has a first condition wherein the first branch 50 transfers power to a first pass-thru receptacle 80, a second pass thru receptacle 90, and a first sub-branch 100. The first sub-branch 110 includes a first twig 120 and a second twig 130. The second twig 130 powers the power consuming device 40. The second branch 60, in the first condition, transfers power to a third pass-thru receptacle 130 and a fourth non-pass-thru receptacle 140. The third branch 70, in the first condition, transfers power to a first switch 150 and a fifth pass-thru receptacle 160. The first switch 150 controls power to a second sub-branch 170.

The system 10 further has a second condition for modularly augmenting the first condition by adding a fourth branch 180, a fifth branch 190, and a sixth branch 200. The fourth branch 180 transfers power to a sixth pass-thru receptacle 210 and a third sub-branch 220. The fifth branch 190 transfers power to a second switch 230 and a fourth sub-branch 240.

The system 10 is converted from the first condition to the second condition by a common source of components, as described above. A system switch 250 may be placed at the junction between the system 10 in the first condition and the second condition in order to facilitate the conversion between the first and second conditions. Further power consuming devices (not shown) may be powered by the first twig 120, second sub-branch 170, third sub-branch 220, fourth sub-branch 240, and the sixth branch 200.

Any number of trunks, branches, sub-branches, twigs, switches, pass-thru receptacles, non-pass-thru receptacles, and power consuming devices may be modularly added to the example system 10 in any configuration. The power source is the only limitation of this type of system expansion.

Although the invention has been described in conjunction with the example embodiment, it is to be appreciated that various modifications may be made without departing from the spirit and scope of the invention as defined by the appended claims.

Having described the invention, we claim:

1. A system for distributing power, said system comprising:
a hub for providing a specific power criteria;
a first trunk for transferring power from said hub to at least one power consuming device;
a first branch for transferring power from said first trunk;
a second branch for transferring power from said first trunk; and
a third branch for transferring power from said first trunk;
said system having a first condition wherein said first branch transfers power to a first pass-thru receptacle, a second pass thru receptacle, and a first sub-branch, said first sub-branch comprising a first twig and a second twig,
said system further having a second condition for modularly augmenting said first condition by adding a fourth branch, a fifth branch, and a sixth branch,
said system being converted from said first condition to said second condition by a common source of components.

2. The system as set forth in claim 1 wherein
said second branch, in said first condition, transfers power to a third pass-thru receptacle and a fourth non-pass-thru receptacle; and
said third branch, in said first condition, transfers power to a first switch and a fifth pass-thru receptacle, said first switch controlling power to a second sub-branch.

3. The system as set forth in claim 2 wherein:
said fourth branch transfers power to a sixth pass-thru receptacle and a third sub-branch; and
said fifth branch transfers power to a second switch and a fourth sub-branch.

4. The system as set forth in claim 3 further including a second trunk for transferring power from said hub to at least one other power consuming device.

5. The system as set forth in claim 4 further including a seventh branch for transferring power from said second trunk, an eighth branch for transferring power from said second trunk, and a ninth branch for transferring power from said second trunk.

6. The system as set forth in claim 5 wherein said system has a third condition wherein said seventh branch transfers power to a seventh pass-thru receptacle, an eighth pass-thru receptacle, and a fifth sub-branch, said fifth sub-branch comprising a third twig and a fourth twig.

7. The system as set forth in claim 6 wherein said eighth branch, in said third condition, transfers power to a ninth pass-thru receptacle and a tenth non-pass-thru receptacle.

8. The system as set forth in claim 7 wherein said ninth branch, in said third condition, transfers power to a third switch and an eleventh pass-thru receptacle, said third switch controlling power to a fifth sub-branch.

9. The system as set forth in claim 8 wherein said system further has a fourth condition for modularly augmenting said third condition by adding a tenth branch, an eleventh branch, and a twelfth branch.

10. The system as set forth in claim 9 wherein said tenth branch transfers power to a twelfth pass-thru receptacle and a sixth sub-branch.

11. The system as set forth in claim 10 wherein said eleventh branch transfers power to a fourth switch and a seventh sub-branch.

12. The system as set forth in claim 11 wherein said system is converted from said third condition to said fourth condition by a common source of components.

13. The system as set forth in claim 12 wherein said system is converted from said second condition to said third condition by a common source of components.

14. A method for distributing power, said method comprising the steps of:
providing hub with a specific power criteria;
transferring power from the hub through a first trunk to at least one power consuming device;
transferring power from the first trunk to a first branch;
transferring power from the first trunk to a second branch;
transferring power from the first trunk to a third branch;
providing a first condition wherein the first branch transfers power to a first pass-thru receptacle, a second pass thru receptacle, and a first sub-branch, the first sub-branch comprising a first twig and a second twig;
transferring power to a third pass-thru receptacle and a fourth non-pass-thru receptacle by the second branch in the first condition;
transferring power to a first switch and a fifth pass-thru receptacle, said first switch controlling power to a second sub-branch by the third branch in the first condition;
providing a second condition for modularly augmenting the first condition by adding a fourth branch, a fifth branch, and a sixth branch;
transferring power to a sixth pass-thru receptacle and a third sub-branch by the fourth branch;
transferring power to a second switch and a fourth sub-branch by the fifth branch; and
converting from the first condition to the second condition by a common source of components.

15. The method as set forth in claim 14 further including the step of transferring power from the hub to at least one other power consuming device by a second trunk.

16. The method as set forth in claim 15 further including the steps of:
transferring power from the second trunk by a seventh branch,
transferring power from the second trunk by an eighth branch; and
transferring power from the second trunk by a ninth branch.

17. The method as set forth in claim 16 further including the step of providing a third condition wherein the seventh branch transfers power to a seventh pass-thru receptacle, an eighth pass-thru receptacle, and a fifth sub-branch, the fifth sub-branch comprising a third twig and a fourth twig.

18. The system as set forth in claim 17 further including the step of providing a fourth condition for modularly augmenting the third condition by adding a tenth branch, an eleventh branch, and a twelfth branch.

19. The method as set forth in claim 18 further including the step of converting from the third condition to the fourth condition by a common source of components.

20. A system for distributing power, said system comprising:
a hub for providing a specific power criteria;
N trunks for transferring power from said hub to at least one power consuming device, N being at least three;
a first branch for transferring power from one of said trunks;
a second branch for transferring power from one of said trunks; and
a third branch for transferring power from one of said trunks;
said system having a first condition wherein said first branch transfers power to a first pass-thru receptacle, a second pass thru receptacle, and a first sub-branch, said first sub-branch comprising a first twig and a second twig,
said system further having a second condition for modularly augmenting said first condition by adding a fourth branch, a fifth branch, and a sixth branch,
said system being converted from said first condition to said second condition by a common source of components.
